(19) United States
(12) Patent Application Publication
(10) Pub. No.: US 2012/0259634 A1
(43) Pub. Date: Oct. 11, 2012

(54) MUSIC PLAYBACK DEVICE, MUSIC PLAYBACK METHOD, PROGRAM, AND DATA CREATION DEVICE

(75) Inventor: Motoki TSUNOKAWA, Chiba (JP)

(73) Assignee: Sony Corporation, Tokyo (JP)

(21) Appl. No.: 13/398,289

(22) Filed: Feb. 16, 2012

(30) Foreign Application Priority Data
Apr. 5, 2011 (JP) 2011-083961

(51) Int. Cl. G10L 15/26

(52) U.S. Cl. 704/235; 704/E15.043

(57) ABSTRACT

There is provided a music playback device comprising a playback unit configured to playback music, an analysis unit configured to analyze lyrics of the music and extract a word or a phrase included in the lyrics, an acquisition unit configured to acquire an image using the word or the phrase extracted by the analysis unit, and a display control unit configured to, during playback of the music, cause a display device to display the image acquired by the acquisition unit.

### BACKGROUND

The present disclosure relates to a music playback device, a music playback method, a program, and a data creation device.

Many of music playback devices so far have been designed to specifically play back music. However, nowadays, music playback devices having the following display functions have also come into widespread use.

(1) Visualizer Function

A function of displaying a predetermined design pattern with a movement in accordance with the rhythm of the music being played back.

(2) Lyrics Display Function

A function of displaying the lyrics of music with the music being played back.

In addition, JP 2005-181646A discloses a technique of displaying an image adapted to the atmosphere of the music being played back (musical instruments and melody).

### SUMMARY

However, with the aforementioned visualizer function, there may be cases in which a displayed design pattern and its movement are not suitable for the atmosphere of the music, which could fatigue the eyes of users. Further, although the lyrics display function is convenient for users, it may not be very interesting. Although it is effective to display an image suitable for the atmosphere of music as in the technique of JP 2005-181646A, elements that characterize the music are not only the atmosphere of the music such as musical instruments and melody.

Thus, the present disclosure proposes a music playback device, a music playback method, a program, and a data creation device that are novel and improved and that can, during playback of music, cause a display device to display an image in accordance with the lyrics of the music.

According to an embodiment of the present disclosure, there is provided a music playback device comprising a playback unit configured to playback music, an analysis unit configured to analyze lyrics of the music and extract a word or a phrase included in the lyrics, an acquisition unit configured to acquire an image using the word or the phrase extracted by the analysis unit, and a display control unit configured to, during playback of the music, cause a display device to display the image acquired by the acquisition unit.

According to another embodiment of the present disclosure, there is provided a music playback method, including analyzing lyrics of music and extracting a word or a phrase included in the lyrics, acquiring an image using the extracted word or phrase, and causing a display device to display the acquired image during playback of the music.

According to a still another embodiment of the present disclosure, there is provided a program for causing a computer to function as a playback unit configured to play back music, an analysis unit configured to analyze lyrics of the music and extract a word or a phrase included in the lyrics, an acquisition unit configured to acquire an image using the word or the phrase extracted by the analysis unit, and a display control unit configured to, during playback of the music, cause a display device to display the image acquired by the acquisition unit.

According to yet another embodiment of the present disclosure, there is provided a data creation device including an analysis unit configured to analyze lyrics of music and extract a word or a phrase included in the lyrics, an acquisition unit configured to acquire an image from a network using the word or the phrase extracted by the analysis unit, and a data creation unit configured to create an image data file associated with the music on the basis of the image acquired by the acquisition unit.

According to the embodiments of the present disclosure described above, it is possible to, during playback of music, cause a display device to display an image in accordance with the lyrics of the music.

### BRIEF DESCRIPTION OF THE DRAWINGS

FIG. 1 is an explanatory diagram showing the configuration of a music playback system in accordance with an embodiment of the present disclosure;

FIG. 2 is an explanatory diagram showing the hardware configuration of a music playback device in accordance with this embodiment;

FIG. 3 is a functional block diagram showing the configuration of a music playback device in accordance with the first embodiment of the present disclosure;

FIG. 4 is an explanatory diagram showing a specific example of a screen displayed in accordance with the first display control;

FIG. 5 is an explanatory diagram showing a specific example of a screen displayed in accordance with the second display control;

FIG. 6 is an explanatory diagram showing a specific example of a screen displayed in accordance with the third display control;

FIG. 7 is an explanatory diagram showing a specific example of a screen displayed in accordance with the fourth display control;

FIG. 8 is an explanatory diagram showing a specific example of a screen displayed in accordance with the fifth display control;

FIG. 9 is a flowchart showing the operation of the music playback device in accordance with the first embodiment;

FIG. 10 is a functional block diagram showing the configuration of a music playback device in accordance with the second embodiment of the present disclosure;

FIG. 11 is an explanatory diagram showing the result of analysis of lyrics in accordance with the second embodiment;

FIG. 12 is an explanatory diagram showing a specific example of an image display in accordance with the second embodiment;

FIG. 13 is a flowchart showing the operation of the music playback device in accordance with the second embodiment;

FIG. 14 is a functional block diagram showing the configuration of a music playback device in accordance with the third embodiment of the present disclosure;

FIG. 15 is an explanatory diagram showing the result of analysis of lyrics in accordance with the third embodiment;

FIG. 16 is an explanatory diagram showing a specific example of an image display in accordance with the third embodiment;

FIG. 17 is a flowchart showing the operation of the music playback device in accordance with the third embodiment; and

FIG. 18 is a functional block diagram showing the configuration of a music playback device in accordance with the fourth embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted by the same reference numerals, and repeated explanation of these structural elements is omitted.

The “DETAILED DESCRIPTION OF THE EMBODIMENTS” will be described in accordance with the following order.
1. Configuration of Music Playback System
2. Description of Each Embodiment
   2-1. First Embodiment
   2-2. Second Embodiment
   2-3. Third Embodiment
   2-4. Fourth Embodiment
3. Conclusion

### 1. Configuration of Music Playback System

The technology in accordance with the present disclosure can be carried out in various modes as exemplarily described in detail in “2-1. First Embodiment” to “2-4. Fourth Embodiment.” In addition, a music playback device 20 in accordance with each embodiment includes:

A. a playback unit (a music playback unit 272) that plays back music;

B. an analysis unit (230) that analyzes the lyrics of the music and extracts words or phrases included in the lyrics;

C. an acquisition unit (a communication unit 264 and a search unit 268) that acquires an image using the words or phrases extracted by the analysis unit; and

D. a display control unit (280) that causes a display device (an image display unit 284) to display the image acquired by the acquisition unit during playback of the music.

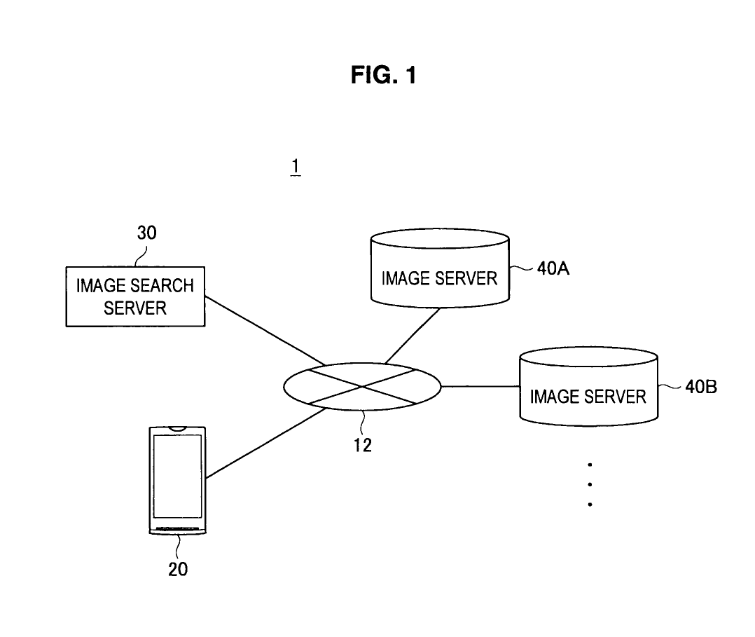

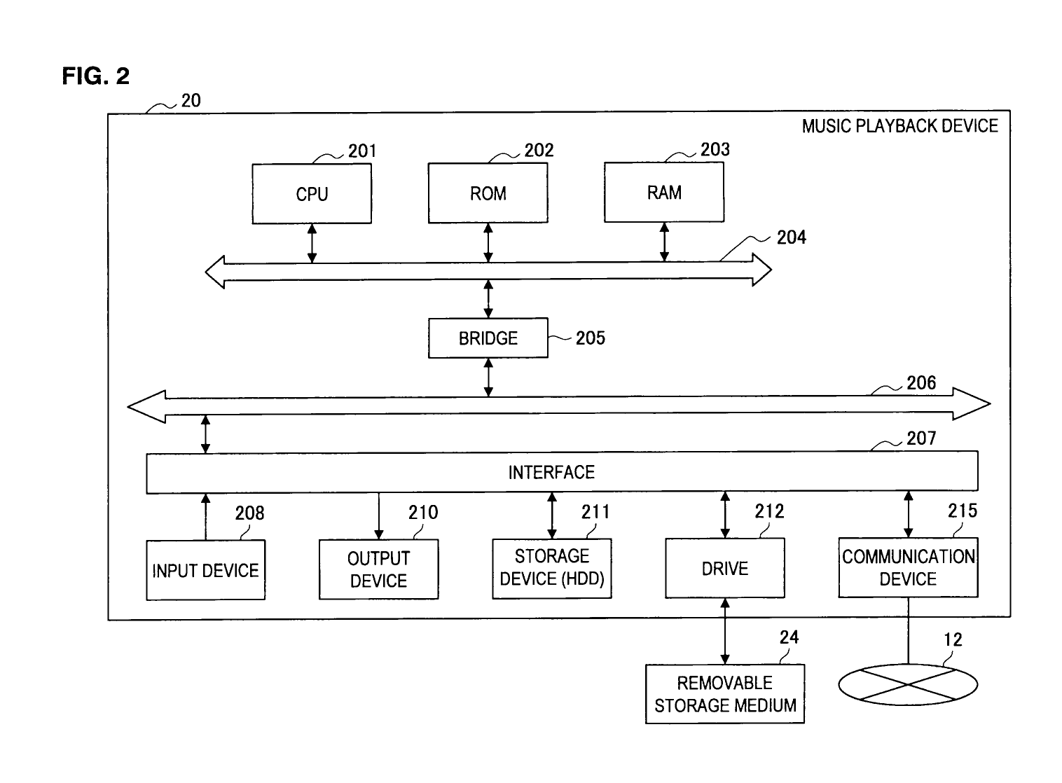

Hereinafter, such basic configuration that is common to each embodiment will be described first with reference to FIG. 1 and FIG. 2.

FIG. 1 is an explanatory diagram showing the configuration of the music playback system 1 in accordance with an embodiment of the present disclosure. As shown in FIG. 1, a music playback system 1 in accordance with an embodiment of the present disclosure includes a communications network 12, a music playback device 20, an image search server 30, and image servers 40A, 40B, . . . .

The communications network 12 is a wire or wireless transmission channel for information transmitted from a device connected to the communications network 12. For example, the communications network 12 may include a public circuit network such as the Internet, a telephone circuit network, or a satellite communications network, various LANs (Local Area Networks) including Ethernet (registered trademark), WAN (Wide Area Network), and the like. In addition, the communications network 12 may include a dedicated circuit network such as IP-VPN (Internet Protocol-Virtual Private Network). In the present disclosure, the music playback device 20, the image search server 30, and the image servers 40A, 40B . . . are connected via the communications network 12.

The image server 40 is a network node that stores images while associating them with words/phrases. Although the present disclosure describes an example in which the images are mainly still images, the images may also be moving images.

The image search server 30 searches for an image from the image server 40 in response to a request from the music playback device 20, and transmits the search result to the music playback device 20. To be more specific, the image search server 30, upon receiving at least one search word/phrase from the music playback device 20, searches for an image that matches the received search word/phrase from the image server 40, and transmits the search result to the music playback device 20.

The music playback device 20 has a music playback function. In addition, the music playback device 20 in accordance with the present disclosure can acquire an image by conducting a search using a word/phrase included in the lyrics of the music, and display the acquired image during playback of the music. Such a music playback device 20 will be described in detail in “2. Description of Each Embodiment.”

Although FIG. 1 shows a portable phone (smartphone) as an example of the music playback device 20, the music playback device 20 is not limited to the portable phone. For example, the music playback device 20 may be an information processing device such as a PC (Personal Computer), a home video processing device (e.g., a DVD recorder or a video cassette recorder), PDA (Personal Digital Assistants), a home game machine, a household electrical appliance, a PHS (Personal Handyphone System), a portable music playback device, a portable video processing device, a portable game machine, or a karaoke machine.

(Hardware Configuration of Music Playback Device)

Hereinafter, the hardware configuration of the music playback device 20 in accordance with the present disclosure will be described with reference to FIG. 2. FIG. 2 is an explanatory diagram showing the hardware configuration of the music playback device 20 in accordance with the present disclosure. As shown in FIG. 20, the music playback device 20 includes a CPU (Central Processing Unit) 201, ROM (Read Only Memory) 202, RAM (Random Access Memory) 203, and a host bus 204. In addition, the music playback device 20 includes a bridge 205, an external bus 206, an interface 207, an input device 208, an output device 210, a storage unit (HDD) 211, a drive 212, and a communication device 215.

The CPU 201 functions as an arithmetic processing unit and a control unit, and controls the entire operation within the music playback device 20 in accordance with various programs. The CPU 201 may be a microprocessor. The ROM 202 stores programs, operation parameters, and the like used by the CPU 201. The RAM 203 temporarily stores programs used in the execution of the CPU 201, parameters that change as appropriate during the execution, and the like. These units are mutually connected via the host bus 204 including a CPU bus or the like.

The host bus 204 is connected to the external bus 206 such as a PCI (Peripheral Component Interconnect/Interface) bus via the bridge 205. Note that the host bus 204, the bridge 205, and the external bus 206 need not necessarily be arranged separately, and the functions of such components may be integrated into a single bus.

The input device 208 includes an input means for a user to input information, such as a mouse, a keyboard, a touch panel, a button, a microphone, a switch, or a lever; an input control circuit that generates an input signal on the basis of a user input and outputs the signal to the CPU 201; and the like. A user of the music playback device 20 can, by operating the input device 208, input various data to the music playback device 20 or instruct the music playback device 20 to perform a processing operation.

The output device 210 includes a display device such as, for example, a CRT (Cathode Ray Tube) display device, a liquid crystal display (LCD) device, an OLED (Organic Light Emitting Diode) device, or a lamp. Further, the output device 210 includes an audio output device such as a speaker or headphones. The output device 210 outputs the played content, for example. Specifically, the display device displays various information such as played video data by means of text or images. Meanwhile, the audio output device converts the played audio data or the like into audio and outputs the audio.

The storage device 211 is a device for storing data, constructed as an example of a storage unit of the music playback device 20 in accordance with this embodiment. The storage device 211 can include a storage medium, a recording device that records data on the storage medium, a reading device that reads data from the storage medium, a deletion device that deletes data recorded on the storage medium, and the like. The storage device 211 includes, for example, a HDD (Hard Disk Drive). The storage device 211 stores programs and various data for driving the hard disk and executed by the CPU 201.

The drive 212 is a reader/writer for a storage medium, and is incorporated in or externally attached to the music playback device 20. The drive 212 reads information recorded on a removable storage medium 24 such as a magnetic disk, an optical disc, a magnetooptical disk, or semiconductor memory that is mounted, and outputs the information to the RAM 203. The drive 212 can also write information to the removable storage medium 24.

The communication device 215 is, for example, a communication interface including a communication device or the like for connection to the communications network 12. The communication device 215 may be any of a communication device supporting a wireless LAN (Local Area Network), a communication device supporting LTE (Long Term Evolution), or a wire communication device that performs wire communication.

### 2. Description of Each Embodiment

Heretofore, the configuration of the music playback system 1 in accordance with the present disclosure has been described. Next, each embodiment of the present disclosure will be sequentially described in detail.

### 2-1. First Embodiment

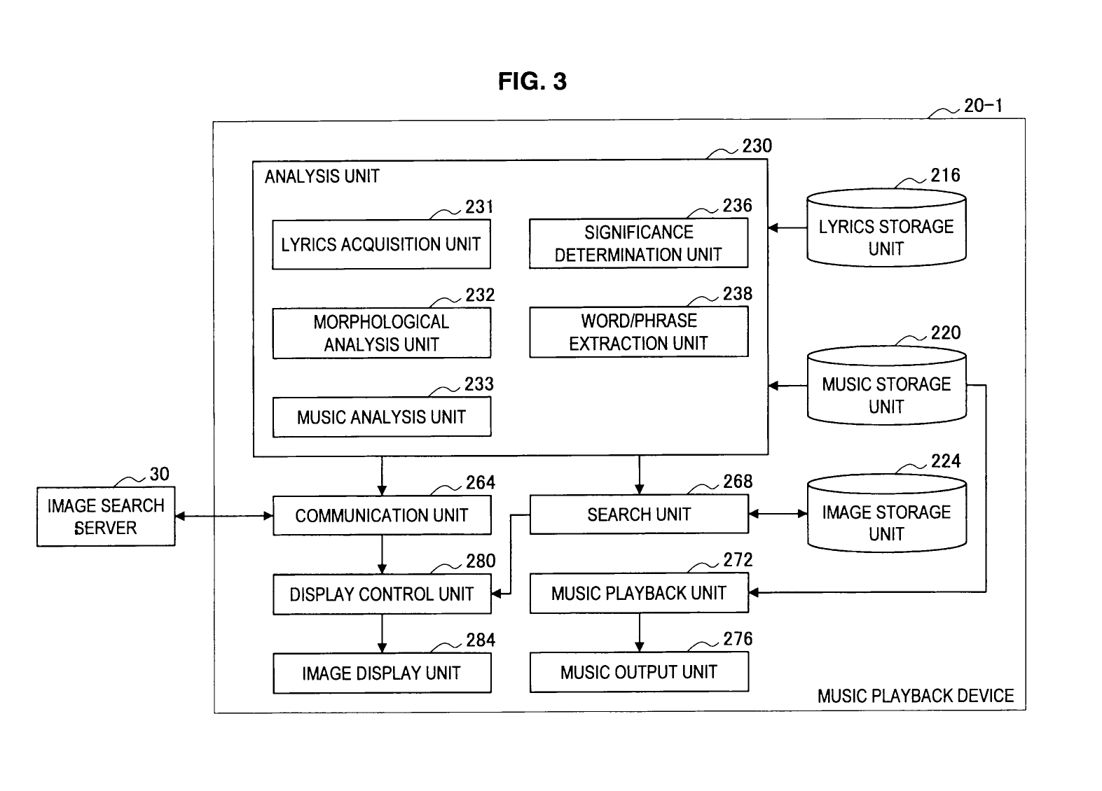

A music playback device 20-1 in accordance with the first embodiment of the present disclosure can analyze the lyrics of music, extract a word/phrase whose significance is high in the lyrics, acquire an image using the extracted word/phrase, and display the acquired image during playback of the music. According to such a configuration, a user can not only audibly perceive the music, but also visually perceive an image in accordance with the lyrics of the music. Thus, the user can enjoy the music more deeply. Hereinafter, such a music playback device 20-1 in accordance with the first embodiment of the present disclosure will be described in detail with reference to FIGS. 3 to 9.

(Configuration of Music Playback Device in accordance with First Embodiment)

FIG. 3 is a functional block diagram showing the configuration of the music playback device 20-1 in accordance with the first embodiment of the present disclosure. As shown in FIG. 3, the music playback device 20-1 in accordance with the first embodiment includes a lyrics storage unit 216, a music storage unit 220, an image storage unit 224, an analysis unit 230, a communication unit 264, a search unit 268, a music playback unit 272, a music output unit 276, a display control unit 280, and an image display unit 284.

The lyrics storage unit 216 stores the lyrics of music stored in the music storage unit 220. The music storage unit 220 stores data for playing back music. The image storage unit 224 stores images while associating them with words/phrases.

Each of the lyrics storage unit 216, the music storage unit 220, and the image storage unit 224 may be a storage medium such as nonvolatile memory, a magnetic disk, an optical disc, or a MO (Magneto Optical) disk. Examples of the nonvolatile memory include EEPROM (Electrically Erasable Programmable Read-Only Memory) and EPROM (Erasable Programmable ROM). Examples of the magnetic disk include hard disks and disk-shaped magnetic bodies. Examples of the optical disc include CD (Compact Disc), DVD-R (Digital Versatile Disc Recordable), and BD (Blu-Ray Disc (registered trademark)).

The analysis unit 230 analyzes the music stored in the music storage unit 220 and the lyrics stored in the lyrics storage unit 216 in relation to the music, and then extracts a search word/phrase for searching for an image. For such a configuration, the analysis unit 230 includes a lyrics acquisition unit 231, a morphological analysis unit 232, a music analysis unit 233, a significance determination unit 236, and a word/phrase extraction unit 238. Note that the analysis unit 230 may execute the following analysis in units of each sentence, each line, each melody part, or the like of the lyrics.

The lyrics acquisition unit 231 acquires the lyrics of the target music from the lyrics storage unit 216. Note that the target music may be any of music that is being played back now, music designated by a user, or music that is stored in the music storage unit 220 and is not played back yet.

The morphological analysis unit 232 analyzes the morpheme of the lyrics acquired by the lyrics acquisition unit 231. For example, when the lyrics acquisition unit 231 acquires the lyrics: “I was born in the deep mountain of Kyoto . . . ,” the morphological analysis unit 232 analyzes the words/phrases (morpheme) that constitute the lyrics as well as the word class of each word/phrase as follows.

“I (personal pronoun)|was (verb)|born (verb)|in (preposition)|the (article)|deep (adjective)|mountain (common noun)|of (preposition)|Kyoto (proper noun) . . . .”

Meanwhile, the music analysis unit 233 analyzes the melody part (e.g., verse, bridge, and chorus), tempo (rhythm), volume, and the like of a portion of the music in which the lyrics to be analyzed appear.

In addition, the significance determination unit 236 determines the significance of each word/phrase obtained by the morphological analysis unit 232. For example, the significance determination unit 236 determines the significance of each word/phrase in accordance with at least one of the following criteria.

### (1) Determination Based on the Word Class

The significance determination unit 236 may determine the significance on the basis of the word class of each word/phrase.

Example: proper nouns→x3, common nouns→x2, other nouns→x1

### (2) Determination Based on the Specialized Dictionary/Table

The significance determination unit 236 may set the significance of words/phrases, which are included in the specialized dictionary/table, high.

Example: The significance of words/phrases that exist in the name dictionary, geographical dictionary, or gourmet dictionary may be set to x3.

### (3) Determination Based on the Number of Appearances

The significance determination unit 236 may determine the significance based on the number of appearances of a word/phrase in the portion of the lyrics to be analyzed.

Example: If a word/phrase appears twice→x2

### (4) Determination Based on the Album Name or the Song Name

The significance determination unit 236 may set the significance of a word/phrase, which has a meaning close to the meaning of the album name or the song name of the target music, high

Example: If the album name is “summer,” the significance of the words “sea,” “sun,” and the like may be set to x2.

### (5) Determination Based on the Genre

The significance determination unit 236 may set the significance of a word/phrase, which has a meaning close to the meaning of the genre of the target music, high.

Example: When the genre is “heavy metal,” the significance of a “scream” may be set to x2.

### (6) Determination Based on the Playback Date/Time and the Playback Place

The significance determination unit 236 may determine the significance of a word/phrase on the basis of the playback date/time and the playback place. Note that the playback place can be estimated using a position estimation technique such as GPS, for example.

Example: When the playback date/time is the “morning,” the significance of the words “morning” and “dawn” may be set to x2.
When the playback place is “Kyoto,” the significance of the word

“Kyoto” may be set to x2.

### (7) Determination Based on the User Preference Information

The significance determination unit 236 may set the significance of a word/phrase on the basis of the user preference information. Note that the user preference information can be acquired from a user's music playback history, a history of words/phrases that have been used for a search of information from the communications network 12, and the like.

Example: When the user preference is a “motorbike,” the significance of the words: “engine” and “brake” may be set to x2.

### (8) Determination Based on the Melody Part

The significance determination unit 236 may adjust the significance in accordance with the melody part of the portion of the lyrics to be analyzed.

Example: the significance may be adjusted so that chorus>bridge>verse is met.

### (9) Determination Based on the Tempo

The significance determination unit 236 may adjust the significance in accordance with the tempo of the portion of the lyrics to be analyzed.

Example: the significance of an up-tempo portion may be set high.

### (10) Determination Based on the Volume

The significance determination unit 236 may adjust the significance in accordance with the volume of the portion of the lyrics to be analyzed.

Example: the significance of a large-volume portion may be set high.

The significance determination unit 236, on the basis of the aforementioned criteria (1) to (3), for example, determines that the significance of the word “Kyoto” in the lyrics: “I was born in the deep mountain of Kyoto . . . ” is “9” as the “Kyoto” is a proper noun, exists in the geographical dictionary, and appears only once. Meanwhile, the significance determination unit 236 determines that the significance of the word: “deep mountain” is “2” as the “deep mountain” is a common noun, does not exist in the specialized dictionary, and appears only once.

The word/phrase extraction unit 238, on the basis of the significance of each word/phrase determined by the significance determination unit 236, extracts a search word/phrase from the words/phrases included in the lyrics. For example, the word/phrase extraction unit 238 may extract the word “Kyoto” whose significance is the highest as a search word/phrase or extract both the word “Kyoto” whose significance is the highest and the phrase “deep mountain” whose significance is the second highest.

Note that the word/phrase extraction unit 238 may determine the number of words/phrases to be extracted on the basis of the number of images to be displayed during playback of the part of the lyrics to be analyzed. For example, when only a single image is displayed during playback of the part of the lyrics to be analyzed, the word/phrase extraction unit 238 may extract only a word/phrase whose significance is the highest as a search word/phrase. Meanwhile, when n images are displayed during playback of the part of the lyrics to be analyzed, the word/phrase extraction unit 238 may extract as search words/phrases a words/phrase whose significance is the highest to a word/phrase whose significance is the n-th highest. Alternatively, when n images are displayed during playback of the part of the lyrics to be analyzed, the word/phrase extraction unit 238 may extract as a search word/phrase at least one word/phrase having higher significance. In such a case, a total of n images are retrieved on the basis of each of the extracted search words/phrases.

The communication unit 264 and the search unit 268 have a function of an acquisition unit that acquires an image on the basis of the search word/phrase extracted by the word/phrase extraction unit 238. Note that the number of images acquired by the communication unit 264 and the search unit 268 may be determined in accordance with the playback time of the part of the lyrics to be analyzed so that a user may be able to fully recognize each image. For example, the longer the playback time of the part of the lyrics to be analyzed, the higher the number of acquired images that is determined.

The communication unit 264 is an interface for communicating with the communications network 12. The communications network 264, for example, transmits the word/phrase (e.g., “Kyoto”) extracted by the analysis unit 230 as a search request to the image search server 30, and receives from the image search server 30 an image retrieved by the image search server 30 using the search word/phrase.

The search unit 268 searches for an image that matches the search word/phrase extracted by the analysis unit 230 from the image storage unit 224 of the music playback device 20-1. Note that the image may be acquired by one or both of the communication unit 264 or the search unit 268. In addition, the communication unit 264 may acquire the image before the playback of the music is started, and the image storage unit 224 may store the image acquired by the communication unit 264 while associating it with the music. In such a case, the search unit 268 may, during playback of the music, acquire the image associated with the music from the image storage unit 224. Note that when a given period of time has elapsed since an image is acquired by the communication unit 264 or when all of the images acquired for given music have been used up for display, the communication unit 264 may acquire images again to update the images in the image storage unit 224. Alternatively, if an image associated with the music is not stored in the image storage unit 224 during playback of the music, the communication unit 264 may acquire images in real time from a network during playback of the music.

The music playback unit 272 reads the playback data of the music to be analyzed from the music storage unit 220 and plays it back. For example, the music playback unit 272 performs decoding, D/A conversion, and the like of the playback data, and supplies a playback signal to the music output unit 276.

The music output unit 276 outputs the playback signal supplied from the music playback unit 272 as audio. The music output unit 276 may be an external music output device such as a speaker, earphones, or headphones.

The display control unit 280 causes the image display unit 284 to display an image, which has been acquired by the communication unit 264 or the search unit 268 on the basis of the search word/phrase, in accordance with the progress of the music played back by the music playback unit 272. Herein, the display control unit 280 can perform display control of the image acquired on the basis of the search word/phrase in various modes as exemplarily shown below. Note that each display control described below can be executed either alone or in combination as appropriate.

### ——First Display Control——

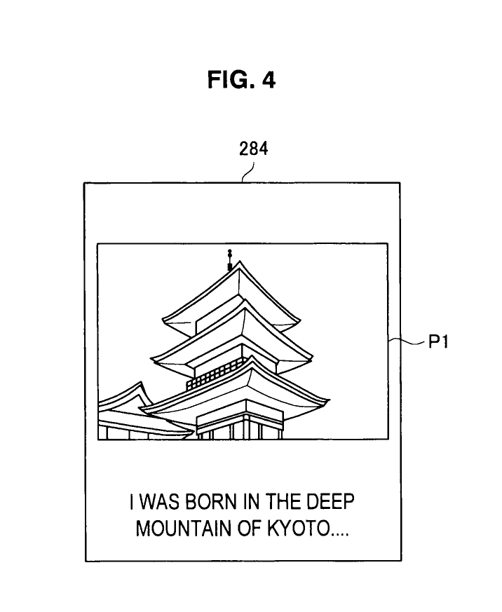

The display control unit 280 may, when a single search word/phrase is extracted by the analysis unit 230 and a single image is retrieved by the communication unit 264 or the search unit 268 using the single search word/phrase, cause the image display unit 284 to display the retrieved image during playback of the portion of the music in which the search word/phrase spears. For example, when the word “Kyoto” is extracted as a search word by the analysis unit 230 and a single image is retrieved by the communication unit 264 or the search unit 268 using the search word “Kyoto”, the display control unit 280 causes the image display unit 284 to display a screen shown in FIG. 4.

FIG. 4 is an explanatory diagram showing a specific example of a screen displayed in accordance with the first display control. As shown in FIG. 4, the display control unit 280, during playback of a portion of the music in which the lyrics: was born in the deep mountain of Kyoto . . . ” appear, displays an image P1 retrieved on the basis of the search word “Kyoto” on the image display unit 284 together with the lyrics. Note that the display control unit 280 need not necessarily display the lyrics on the image display unit 284.

More specifically, the display control unit 280 may control the display size of the image in accordance with the significance of the search word/phrase. For example, the display control unit 280 may increase the display size of the image as the significance of the search word/phrase is higher. Herein, the significance of the search word/phrase also depends on the melody part, tempo, volume, and the like. Thus, the display size of the image is controlled on the basis of the melody part, tempo, volume, and the like.

Note that the display control unit 280 may cause the image display unit 284 to display the image acquired using the search word/phrase at a position different from the portion of the music in which the search word/phrase appears. For example, as the lyrics of the chorus portion in the music can be understood as the most impressive, representative portion of the music for a song writer, the display control unit 280 may, during playback of the whole music, cause the image display unit 284 to display an image acquired using a search word/phase included in the chorus portion. In addition, the display control unit 280 may, in order to obtain a foreshadowing effect, cause the image display unit 284 to display, during playback of a given melody part, an image acquired using a search word/phrase included in the next melody part.

### ——Second Display Control——

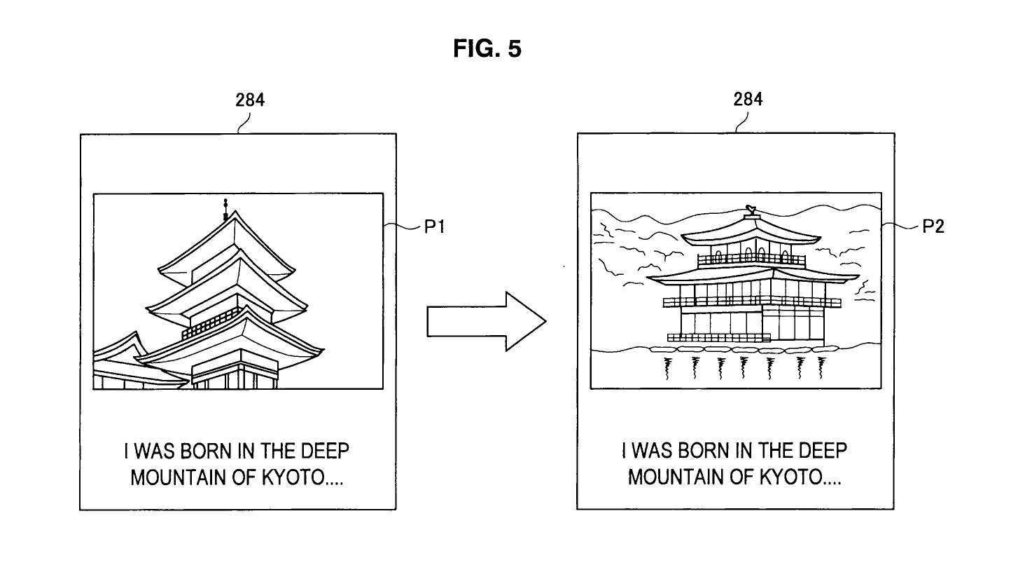

The display control unit 280 may, when a single search word/phrase is extracted by the analysis unit 230 and a plurality of images are retrieved by the communication unit 264 or the search unit 268 using the single search word/phrase, cause the image display unit 284 to sequentially display the plurality of retrieved images during playback of the portion of the music in which the search word/phrase appears. For example, when the word “Kyoto” is extracted as a search word by the analysis unit 239, and two images are retrieved by the communication unit 264 or the search unit 268 on the basis of the search word “Kyoto,” the display control unit 280 causes the image display unit 284 to display screens shown in FIG. 5.

FIG. 5 is an explanatory diagram showing a specific example of screens displayed in accordance with the second display control. As shown in FIG. 5, the display control unit 280, when playback of a portion of the music in which the lyrics: “I was born in the deep mountain of Kyoto . . . ” appear is started, first causes the image display unit 284 to display one of the images P1 retrieved on the basis of the search word “Kyoto.” Then, with the progress of the playback of the portion of the music in which the lyrics: “I was born in the deep mountain of Kyoto . . . ” appear, the display control unit 280 switches the display of the image display unit 284 to the other image P2 retrieved on the basis of the search word “Kyoto.”

Note that the display control unit 280 may also switch between images through fade-in or fade-out. For example, the display control unit 280 may, when switching the image from the image P1 to the image P2, gradually decrease the α blend value (transparency) of the image P1 and gradually increase the a blend value of the image P2.

### ——Third Display Control——

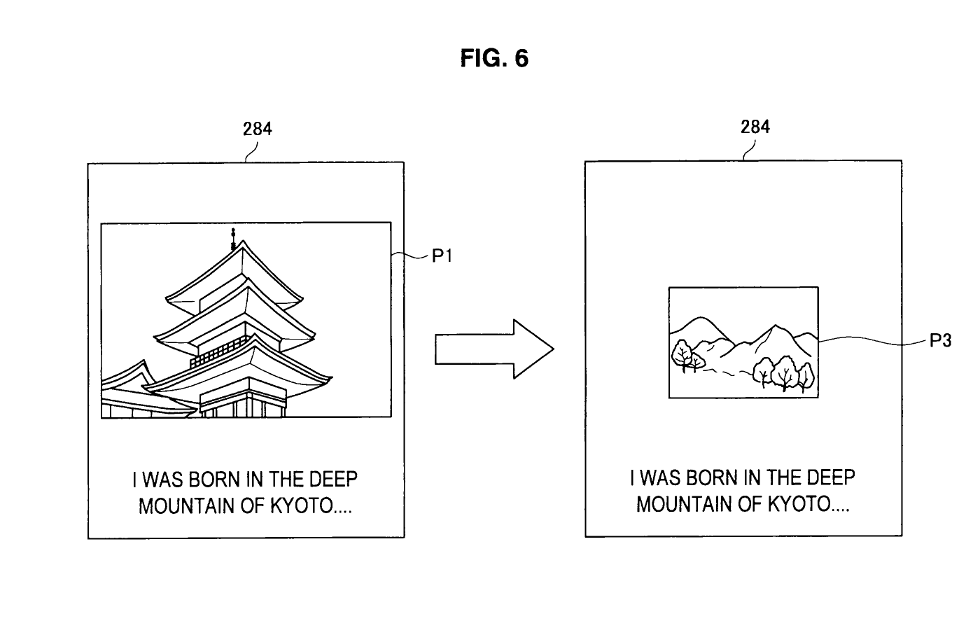

The display control unit 280 may, when a plurality of search words/phrases are extracted by the analysis unit 230 and images are retrieved by the communication unit 264 or the search unit 268 using the respective search words/phrases, cause the image display unit 284 to sequentially display the images retrieved using the respective search word/phrases during playback of the corresponding portion of the music. For example, when the words “Kyoto” and “deep mountain” are extracted as search words/phrases by the analysis unit 230 and images are retrieved by the communication unit 264 or the search unit 268 on the basis of the respective search words/phrases “Kyoto” and “deep mountain,” the display control unit 280 causes the image display unit 284 to display screens shown in FIG. 6.

FIG. 6 is an explanatory diagram showing a specific example of screens displayed in accordance with the third display control. As shown in FIG. 6, the display control unit 280, when playback of a portion of the music in which the lyrics: “I was born in the deep mountain of Kyoto . . . ” appear is started, causes the image display unit 284 to display the image P1 retrieved using the search word “Kyoto.” Then, with the progress of the playback of the portion of the music in which the lyrics: was born in the deep mountain of Kyoto . . . ” appear, the display control unit 280 switches the display of the image display unit 284 to the image P3 retrieved using the search phrase “deep mountain.”

Herein, the significance of the search word “Kyoto” is “9” while the significance of the search phrase “deep mountain” is “2.” Thus, as shown in FIG. 6, control is performed so that the display size of the image P3 retrieved using the search phrase “deep mountain” becomes smaller than the display size of the image P1.

### ——Fourth Display Control——

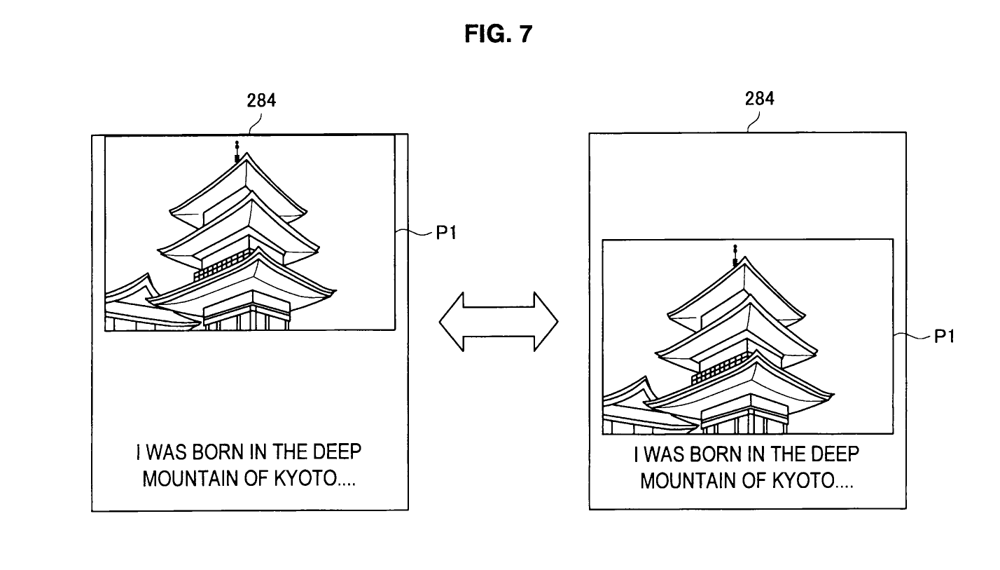

The display control unit 280 may add to the image retrieved by the communication unit 264 or the search unit 268 a movement in accordance with the beat and rhythm of the music (e.g., shake, expansion/contraction, or rotation of the image). For example, when the word “Kyoto” is extracted as a search word by the analysis unit 230 and an image is retrieved by the communication unit 264 or the search unit 268 on the basis of the search word “Kyoto,” the display control unit 280 performs the display control shown in FIG. 7.

FIG. 7 is an explanatory diagram showing a specific example of a screen displayed in accordance with the fourth display control. As shown in FIG. 7, the display control unit 280, during playback of a portion of the music in which the lyrics: “I was born in the deep mountain of Kyoto . . . ” appear, swings the image P1 retrieved on the basis of the search word: “Kyoto” up and down on the screen.

Herein, the display control unit 280 may swing the image P1 with an intensity corresponding to the rhythm of the music. Such fourth display control allows the display mode of the image P1 to reflect the atmosphere of the music.

### ——Fifth Display Control——

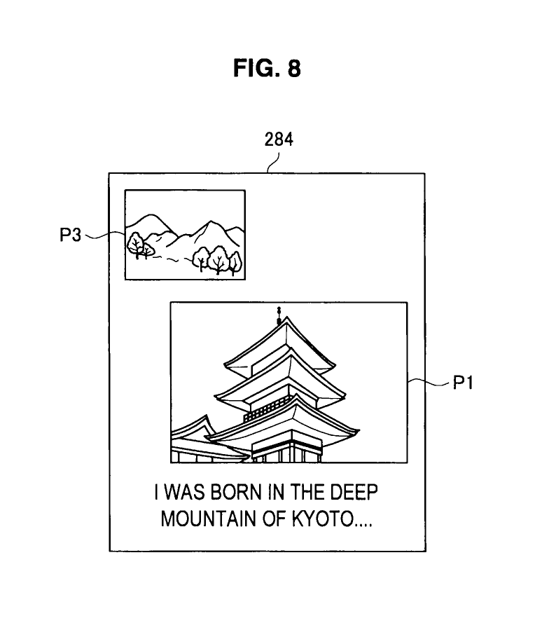

The display control unit 280 may, when a plurality of images are retrieved by the communication unit 264 or the search unit 268, cause the image display unit 284 to simultaneously display the plurality of images in different regions during playback of the portion of the music in which the search word/phrase appears. For example, when the words/phrases “Kyoto” and “deep mountain” are extracted by the analysis unit 230 as search words/phrases and images are retrieved by the communication unit 264 or the search unit 268 on the basis of the respective search words/phrases “Kyoto” and “deep mountain,” the display control unit 280 causes the image display unit 284 to display a screen shown in FIG. 8.

FIG. 8 is an explanatory diagram showing a specific example of a screen displayed in accordance with the fifth display control. As shown in FIG. 8, the display control unit 280, during playback of a portion of the music in which the lyrics: “I was born in the deep mountain of Kyoto . . . ” appear, causes the image display unit 284 to simultaneously display the images P1 and P3 retrieved on the basis of the respective search words/phrases “Kyoto” and “deep mountain” in different regions. Herein, the significance of the search word “Kyoto” is “9” and the significance of the search phrase “deep mountain” is “2.” Thus, as shown in FIG. 8, control is performed so that the display size of the image P3 retrieved using the search phrase “deep mountain” becomes smaller than the display size of the image P1.

Although FIG. 8 shows an example in which a plurality of images are displayed in different regions of the image display unit 284, the display control unit 280 may also cause the image display unit 284 to display a plurality of images in an overlapped manner while setting the transparency of each image. In such a case, the display control unit 280 may set the transparency of an image, which has been retrieved using a less significant search word/phrase, to be lower.

The display control of images by the display control unit 280 has been described above. Note that the display control unit 280 may handle an image, which has been once displayed during playback of the music, such that the image will be not used in succession, used after a given interval of time has elapsed, or not used at all.

(Operation of the Music Playback Device in accordance with First Embodiment)

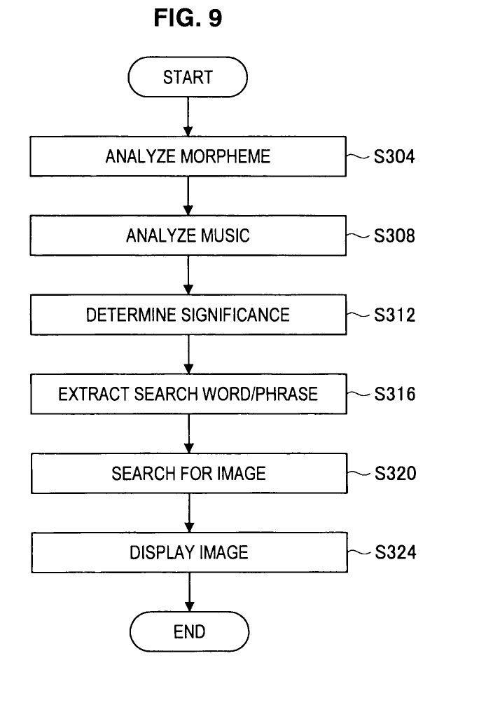

Next, the operation of the music playback device 20-1 in accordance with the first embodiment of the present disclosure will be described with reference to FIG. 9.

FIG. 9 is a flowchart showing the operation of the music playback device 20-1 in accordance with the first embodiment. As shown in FIG. 9, the morphological analysis unit 232 of the music playback device 20-1 first analyzes the lyrics of at least a part of the target music (S304). In addition, the music analysis unit 233 analyzes the melody part, tempo, and the like of the target music (S308).

After that, the significance determination unit 236 determines the significance of each word/phrase included in the lyrics on the basis of the result of analysis performed by the morphological analysis unit 232 and the music analysis unit 233 (S312). Next, the word/phrase extraction unit 238 extracts a word/phrase whose significance is high as a search word/phrase (S316).

Then, the communication unit 264 operates in cooperation with the image search server 30, or the search unit 268 acquires an image using the search word/phrase extracted by the word/phrase extraction unit 238 (S320). After that, the display control unit 280 causes the image display unit 284 to display the image acquired by the communication unit 264 or the search unit 268 in accordance with the progress of the music being played back (S324).

As described above, according to the first embodiment of the present disclosure, it is possible to analyze the lyrics of music, extract a word/phrase whose significance is high in the lyrics, acquire an image using the extracted word/phrase, and display the acquired image during playback of the music. According to such a configuration, a user can not only audibly perceive the music, but also visually perceive an image in accordance with the lyrics of the music. Thus, the user can enjoy the music more deeply.

### 2-2. Second Embodiment

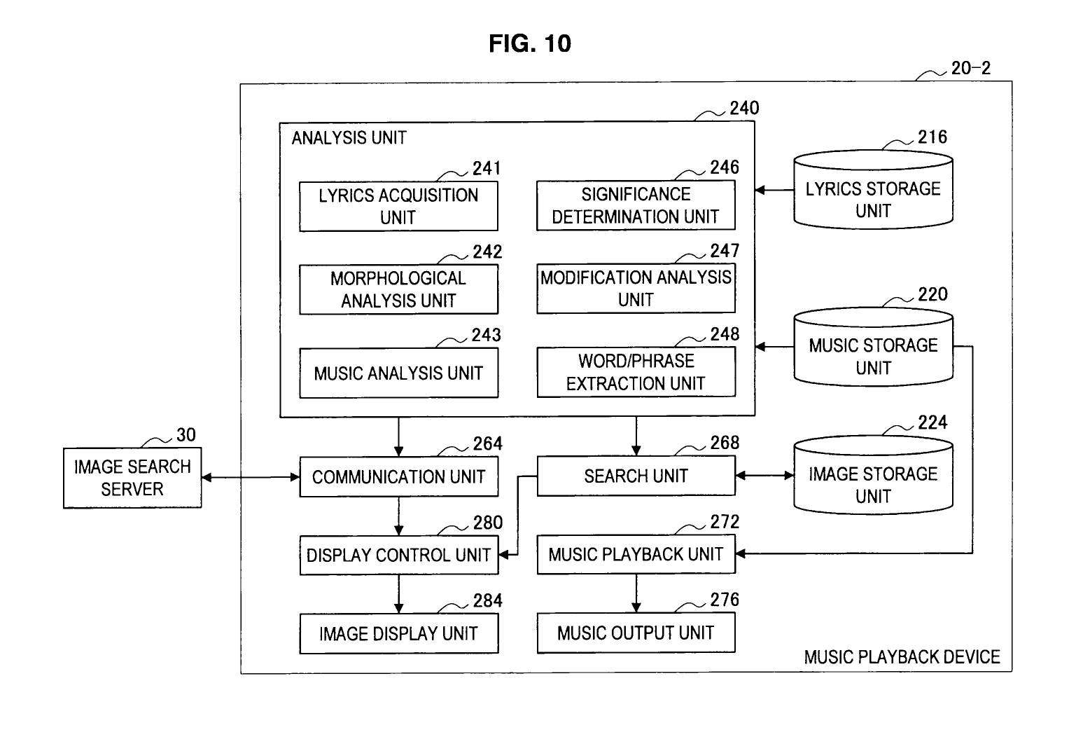

Next, the second embodiment of the present disclosure will be described. The music playback device 20-2 in accordance with the second embodiment of the present disclosure can analyzes the lyrics of music, extract a word/phrase whose significance is high in the lyrics, extract a word/phrase related to the word/phrase whose significance is high, acquire an image using the plurality of extracted words/phrases, and display the acquired image during playback of the music. Hereinafter, the music playback device 20-2 in accordance with the second embodiment of the present disclosure will be described in detail with reference to FIGS. 10 to 13.

(Configuration of Music Playback Device in accordance with Second Embodiment)

FIG. 10 is a functional block diagram showing the configuration of a music playback device 20-2 in accordance with the second embodiment of the present disclosure. As shown in FIG. 10, the music playback device 20-2 in accordance with the second embodiment includes a lyrics storage unit 216, a music storage unit 220, an image storage unit 224, an analysis unit 240, a communication unit 264, a search unit 268, a music playback unit 272, a music output unit 276, a display control unit 280, and an image display unit 284. The aforementioned configuration of the music playback device 20-2 includes a configuration common to the configuration of the music playback device 20-1 in accordance with the first embodiment. Thus, hereinafter, a configuration that is different from the configuration of the music playback device 20-1 in accordance with the first embodiment will mainly be described.

The analysis unit 240 analyzes the music stored in the music storage unit 220 and the lyrics stored in the lyrics storage unit 216 in relation to the music, and extracts a search word/phrase set for searching for images. For such a configuration, the analysis unit 240 includes a lyrics acquisition unit 241, a morphological analysis unit 242, a music analysis unit 243, a significance determination unit 246, a modification analysis unit 247, and a word/phrase extraction unit 238. Note that the analysis unit 240 may execute the following analysis in units of each sentence, each line, each melody part, or the like of the lyrics.

The lyrics acquisition unit 241 acquires the lyrics of the target music from the lyrics storage unit 216. Note that the target music may be any of music that is being played back now, music designated by a user, or music that is stored in the music storage unit 220 and is not played back yet.

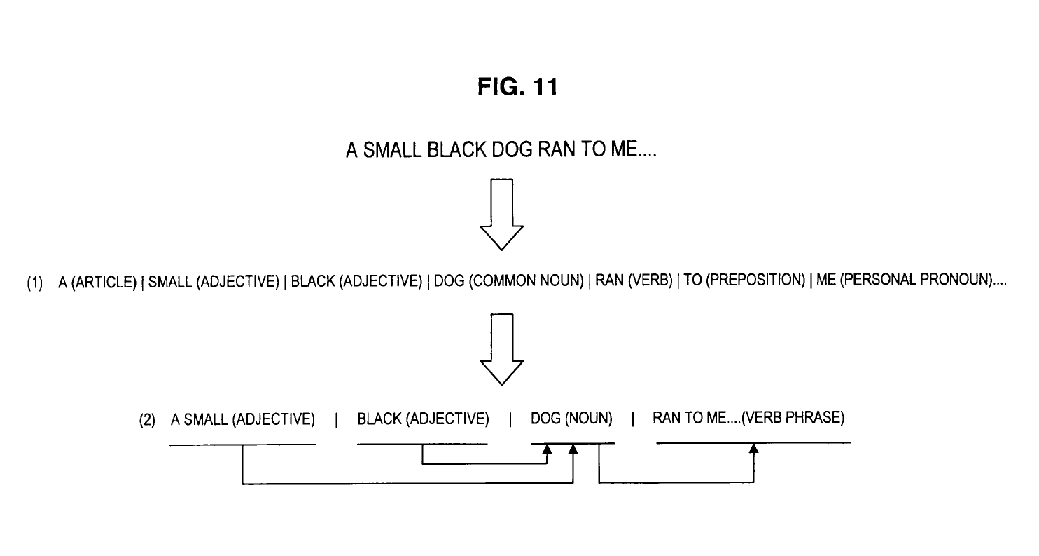

The morphological analysis unit 242 analyzes the morpheme of the lyrics acquired by the lyrics acquisition unit 241. For example, when the lyrics acquisition unit 241 acquires the lyrics: “a small black dog ran to me . . . ,” the morphological analysis unit 242 analyzes the words/phrases (morpheme) that constitute the lyrics as well as the word class of each word/phrase as shown in (1) in FIG. 11.

FIG. 11 is an explanatory diagram showing the result of analysis of the lyrics in accordance with the second embodiment. As shown in (1) in FIG. 11, the lyrics: “a small black dog ran to me . . . ” is broken down into “A (article)|small (adjective)|black (adjective)|dog (common noun)|ran (verb)|to (preposition)|me (personal pronoun) . . . .”

Meanwhile, the music analysis unit 243 analyzes the melody part (e.g., verse, bridge, chorus), tempo (rhythm), volume, and the like of a portion of the music in which the lyrics to be analyzed appear.

In addition, the significance determination unit 246 determines the significance of each word/phrase obtained by the morphological analysis unit 242. The significance determination unit 246 may determine the significance of each word/phrase in accordance with at least one of the criteria (1) to (10) described in the first embodiment, for example.

In such a case, the significance determination unit 246, on the basis of the criteria (1) to (3), determines that the significance of the word “dog” in the lyrics: “a small black dog ran to me . . . ” is “2” as the “dog” is a common noun, does not exist in the specialized dictionary, and appears only once.

The modification analysis unit 247 analyzes the modification of each word/phrase obtained by the morphological analysis unit 242. By the modification analysis, it is found, for example, that in the lyrics: “a small black dog ran to me . . . ,” the word “dog” is modified by the words “black” and “small” as shown in (2) in FIG. 11.

The word/phrase extraction unit 248 extracts a word/phrase whose significance is determined to be the highest by the significance determination unit 246 and a word/phrase that modifies the word/phrase whose significance is the highest. For example, in the lyrics: “a small black dog ran to me . . . ,” a word whose significance is the highest is the “dog” and words/phrases that modify the word “dog” are “black” and “small.” Thus, the word/phrase extraction unit 248 extracts the words “dog,” “black,” and “small” as a set of search words/phrases (a search word/phrase set).

Note that the word/phrase extraction unit 248 may determine the number of search word/phrase sets extracted on the basis of the number of images to be displayed during playback of a portion of the lyrics to be analyzed. For example, the word/phrase extraction unit 248 may, when only one image is displayed during playback of a portion of the lyrics to be analyzed, extract only a search word/phrase set including the most significant word/phrase. Meanwhile, the word/phrase extraction unit 248 may, when n images are displayed during playback of a portion of the lyrics to be analyzed, extract a search word/phrase set including the most significant word/phrase to a search word/phrase set including the n-th highest significant word/phrase. In addition, the word/phrase extraction unit 248 may, when n images are displayed during playback of a portion of the lyrics to be analyzed, extract at least one search word/phrase set including a combination of at least one word/phrase whose significance is higher and a word/phrase that modifies the word/phrase whose significance is higher. In such a case, images are searched for on the basis of each of the extracted search word/phrase sets so that a total of n images are retrieved.

The communication unit 264 and the search unit 268 acquire an image using the search word/phrase set extracted by the analysis unit 240 as in the first embodiment. Specifically, the communication unit 264 and the search unit 268 may acquire an image through AND operation of a plurality of words/phrases that constitute the search word/phrase set. In addition, the communication unit 264 and the search unit 268 may, if the search priority can be designated, increase the priority of a modified word/phrase in the search word/phrase set.

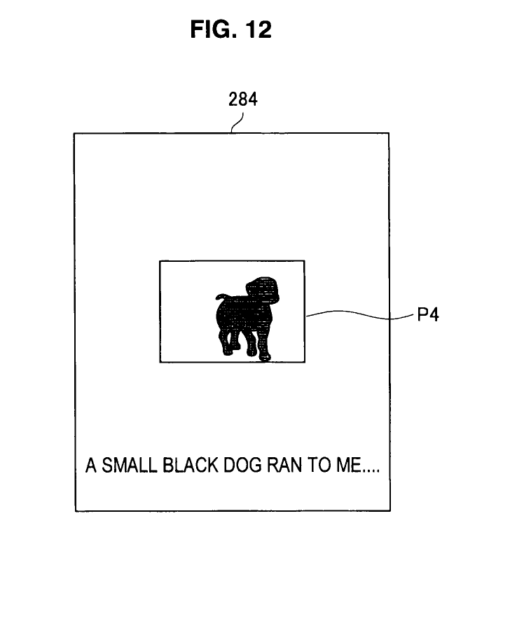

The music playback unit 272, the music output unit 276, the display control unit 280, and the image display unit 284 operate so that an image acquired by the communication unit 264 or the search unit 268 is displayed in accordance with the progress of the music as in the first embodiment. For example, when an image is acquired using a search word/phrase set including the words: “dog,” “black,” and “small,” the image display unit 284 displays an image shown in FIG. 12.

FIG. 12 is an explanatory diagram showing a specific example of an image display in accordance with the second embodiment. As shown in FIG. 12, the display control unit 280, during playback of a portion of music in which the lyrics: “a small black dog ran to me . . . ” appear, causes the image display unit 284 to display an image P4 that has been retrieved using a search word/phrase set including the words: “dog,” “black,” and “small.”

When the significance of the word “dog” is “2,” which is a relatively low level, and the rhythm of the song is slow tempo, the display control unit 280 may cause the image display unit 284 to display the image P4 in a relatively small display size while swinging the image P4 like ripples in accordance with any of the first to fifth display control described in the first embodiment.

(Operation of Music Playback Device in accordance with Second Embodiment)

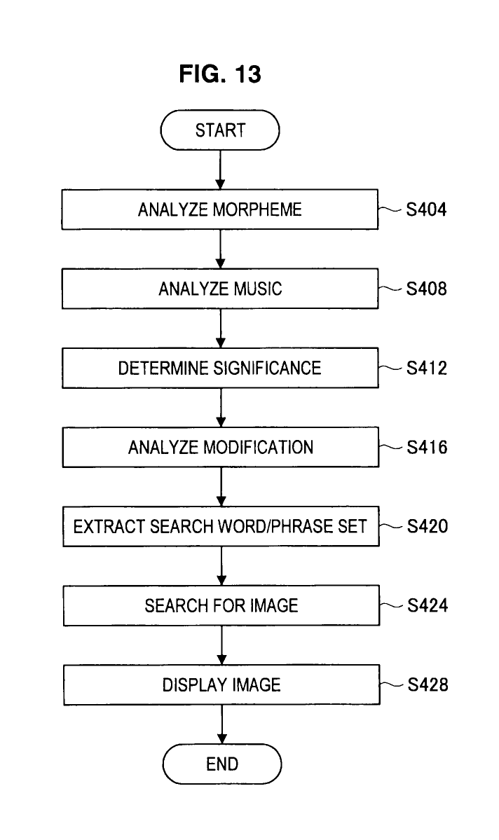

The configuration of the music playback device 20-2 in accordance with the second embodiment has been described above. Next, the operation of the music playback device 20-2 in accordance with the second embodiment will be described with reference to FIG. 13.

FIG. 13 is a flowchart showing the operation of the music playback device 20-2 in accordance with the second embodiment. As shown in FIG. 13, first, the morphological analysis unit 242 of the music playback device 20-2 analyzes the lyrics of at least a part of the target music (S404). In addition, the music analysis unit 243 analyzes the melody part, tempo, and the like of the target music (S408).

After that, the significance determination unit 246 determines the significance of each word/phrase included in the lyrics on the basis of the result of analysis performed by the morphological analysis unit 242 and the music analysis unit 243 (S412). In addition, the modification analysis unit 247 analyzes the modification of each word/phrase obtained by the morphological analysis unit 242 (S416). Note that the process of S416 may be performed before the process of S412, or the process of S416 and the process of S412 may be performed in parallel.

Next, the word/phrase extraction unit 248 extracts, as a search word/phrase set, a word/phrase whose significance is high as well as a word/phrase that modifies the word/phrase whose significance is high (S420). Then, the communication unit 264 operates in cooperation with the image search server 30, or the search unit 268 acquires an image using the search word/phrase set extracted by the word/phrase extraction unit 248 (S424). After that, the display control unit 280 causes the image display unit 284 to display the image acquired by the communication unit 264 or the search unit 268 in accordance with the progress of the music being played back (S428).

As described above, the music playback device 20-2 in accordance with the second embodiment of the present disclosure can analyze the lyrics of music, extract a word/phrase whose significance is high in the lyrics, extract a word/phrase that modifies the word/phrase whose significance is high, acquire an image using the plurality of extracted words/phrases, and display the acquired image during playback of the music.

### 2-3. Third Embodiment

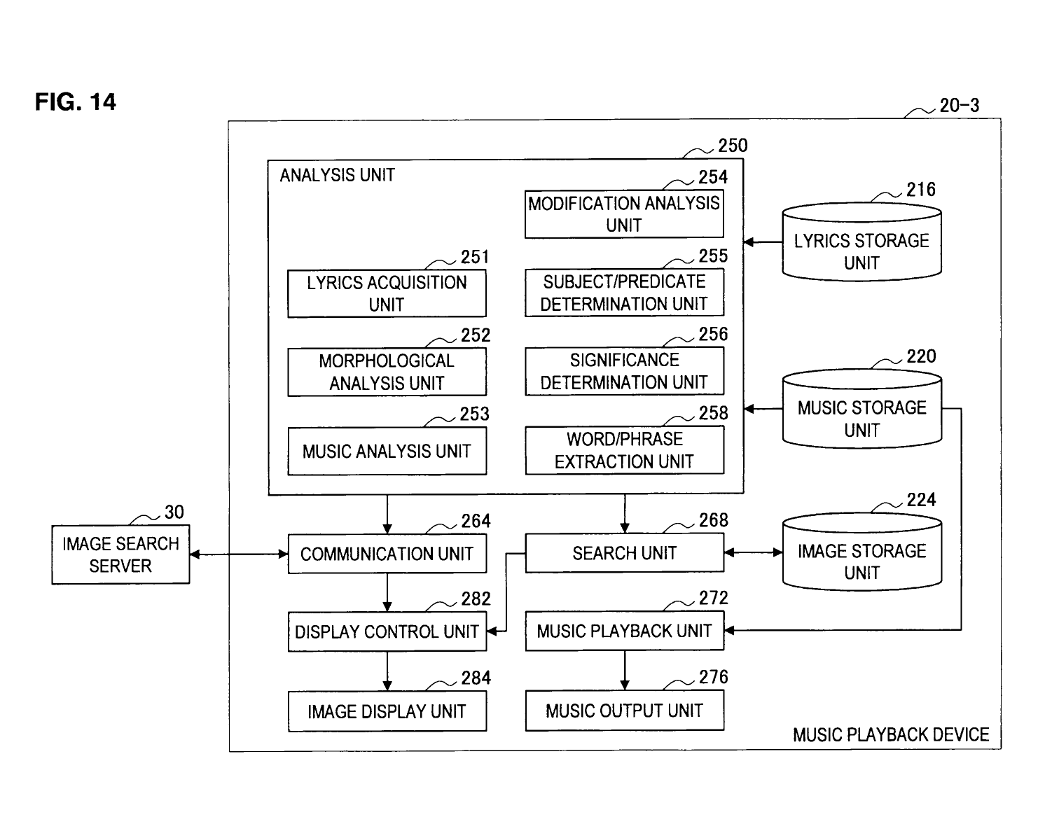

Next, the third embodiment of the present disclosure will be described. The music playback device 20-3 in accordance with the third embodiment of the present disclosure can analyze the lyrics of music, analyze the subject and predicate that constitute the lyrics, extract a noun from the subject as a search word/phrase, acquires an image using the extracted word/phrase, and display the acquired image with a movement in accordance with the predicate during playback of the music. Hereinafter, the music playback device 20-3 in accordance with the third embodiment of the present disclosure will be described in detail with reference to FIGS. 14 to 17.

FIG. 14 is a functional block diagram showing the configuration of the music playback device 20-3 in accordance with the third embodiment of the present disclosure. As shown in FIG. 14, the music playback device 20-3 in accordance with the third embodiment includes a lyrics storage unit 216, a music storage unit 220, an image storage unit 224, an analysis unit 250, a communication unit 264, a search unit 268, a music playback unit 272, a music output unit 276, a display control unit 282, and an image display unit 284. The aforementioned configuration of the music playback device 20-3 includes a configuration that is common to the music playback device 20-1 in accordance with the first embodiment. Thus, hereinafter, a configuration that is different from the configuration of the music playback device 20-1 in accordance with the first embodiment will mainly be described.

The analysis unit 250 analyzes the music stored in the music storage unit 220 and the lyrics stored in the lyrics storage unit 216 in relation to the music, and extracts a search word/phrase for searching for images. For such a configuration, the analysis unit 250 includes a lyrics acquisition unit 251, a morphological analysis unit 252, a music analysis unit 253, a modification analysis unit 254, a subject/predicate determination unit 255, a significance determination unit 256, and a word/phrase extraction unit 258. Note that the analysis unit 250 may execute the following analysis in units of each sentence, each line, each melody part, or the like of the lyrics.

The lyrics acquisition unit 251 acquires the lyrics of the target music from the lyrics storage unit 216. Note that the target music may be any of music that is being played back now, music designated by a user, or music that is stored in the music storage unit 220 and is not played back yet.

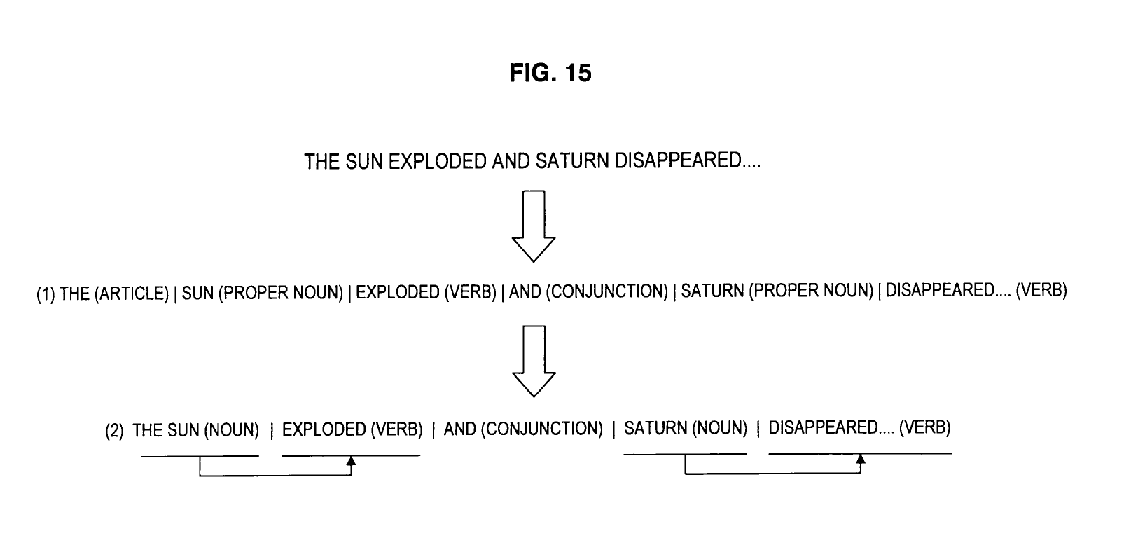

The morphological analysis unit 252 analyzes the morpheme of the lyrics acquired by the lyrics acquisition unit 251. For example, when the lyrics acquisition unit 251 acquires the lyrics: “the sun exploded and Saturn disappeared . . . ,” the morphological analysis unit 252 analyzes the words/phrases that constitute the lyrics as well as the word class of each word/phrase as shown in (1) in FIG. 15.

FIG. 15 is an explanatory diagram showing the result of analysis of lyrics in accordance with the third embodiment. As shown in (1) in FIG. 15, the lyrics: “the sun exploded and Saturn disappeared . . . ” is broken down into “the (article)|sun (proper noun)|exploded (verb)|and (conjunction)|Saturn (proper noun)|disappeared . . . (verb).”

Meanwhile, the music analysis unit 253 analyzes the melody part (e.g., verse, bridge, chorus), tempo (rhythm), volume, and the like of a portion of the music in which the lyrics to be analyzed appear.

In addition, the modification analysis unit 254 analyzes the modification of each word/phrase obtained by the morphological analysis unit 252. By the modification analysis, it is found, for example, that in the lyrics: “the sun exploded and Saturn disappeared . . . ,” the word “exploded” is modified by the word “sun” as shown in (2) in FIG. 15.

The subject/predicate determination unit 255 determines the subject and predicate of each sentence that constitutes the lyrics. For example, the subject/predicate determination unit 255 determines the subject and predicate of each of a simple sentence, a compound sentence, and a complex sentence as follows.
Simple Sentence: “The dog runs.”

Subject=“the dog” Predicate=“runs”
Compound Sentence: “The dog runs and the cat cries.”

The first subject=“the dog” The first predicate=“runs”

The second subject=“the cat” The second predicate=“cries”
Complex Sentence: “The cat follows the dog that is running.”

The first subject=“the dog” The first predicate=“is running”

The second subject=“the cat” The second predicate “follows”

Likewise, the subject/predicate determination unit 255 determines the subject and predicate of the lyrics: “the sun exploded and Saturn disappeared . . . ” as follows. Note that when there exists a plurality of pairs of subjects and predicates as described below, the following process is performed on each pair of the subject and predicate.

The first subject=“the sun” The first predicate=“exploded”

The second subject=“Saturn” The second predicate=“disappeared”

The significance determination unit 256 determines the significance of each word/phrase that constitutes the subject determined by the subject/predicate determination unit 255. The significance determination unit 256 may determine the significance of each word/phrase in accordance with at least one of the criteria (1) to (10) described in the first embodiment, for example.

In this case, the significance determination unit 256 determines that the significance of the word “sun” that constitutes the subject is “3” as the “sun” is a proper noun, does not exist in the specialized dictionary, and appears only once.

The word/phrase extraction unit 258 extracts a word/phrase whose significance is determined to be the highest by the significance determination unit 256. For example, the word/phrase extraction unit 258 extracts the “sun” as a search word from the first subject that constitutes the lyrics: “the sun exploded and Saturn disappeared . . . .”

The communication unit 264 and the search unit 268 acquire an image using the search word/phrase extracted by the analysis unit 250 as in the first embodiment. The music playback unit 272 reads playback data of the music to be analyzed from the music storage unit 220 as in the first embodiment, and the music output unit 276 outputs a playback signal supplied by the music playback unit 272 as audio.

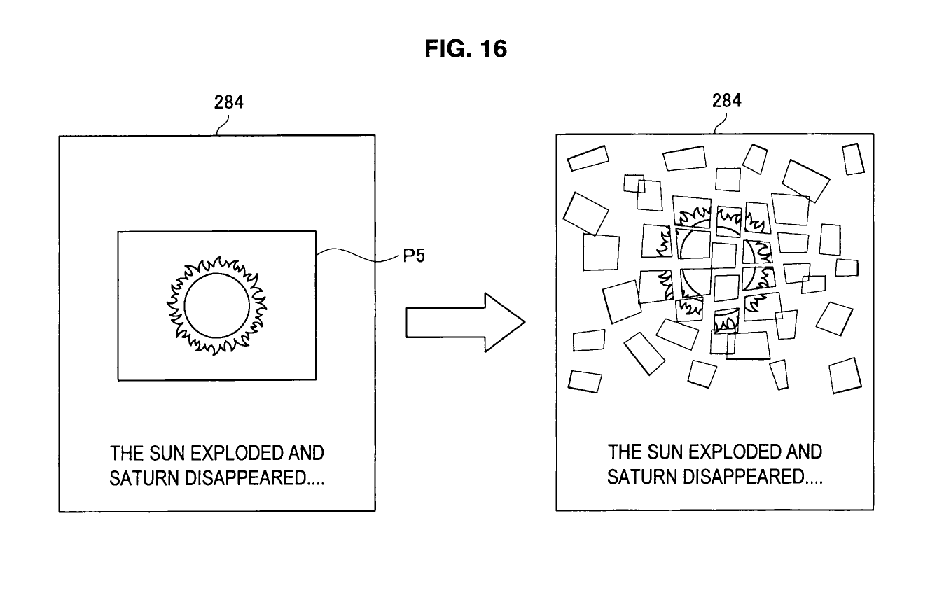

The display control unit 282 causes the image display unit 284 to display the image, which has been acquired by the communication unit 264 or the search unit 268 on the basis of the search word/phrase, with a movement in accordance with the predicate determined by the subject/predicate determination unit 255. More specifically, the display control unit 282 may prepare a table in which predicates are associated with movement patterns, and perform display control of an image in accordance with the movement pattern associated with the predicate in the table. For example, when the predicate “run” is associated with a movement pattern “move from side to side” and the predicate “explode” is associated with a movement pattern “rupture” in the table, the display control unit 282 performs the display control shown in FIG. 16.

FIG. 16 is an explanatory diagram showing a specific example of an image display in accordance with the third embodiment. As shown in FIG. 16, the display control unit 282, when playback of a portion of music in which the lyrics: “the sun exploded and Saturn disappeared . . . ” appear is started, causes the image display unit 284 to display an image P5 acquired using the search word “sun.” After that, the display control unit 282 ruptures the image P5 (breaks the image into smaller parts and scatters them) in accordance with a movement pattern associated with the predicate “explodes.”

Note that when the predicate is a negative form, the display control unit 282 may perform display control by, for example, displaying x on the entire screen so that it is clearly understood that the predicate is a negative form. In addition, image search and display control can be performed using not only a subject and predicate but also an object. Further, it is also possible to determine the atmosphere of music by analyzing words/phrases included in the lyrics or the music, and add to the image a movement that matches the atmosphere of the music.

(Operation of Music Playback Device in Accordance with Third Embodiment)

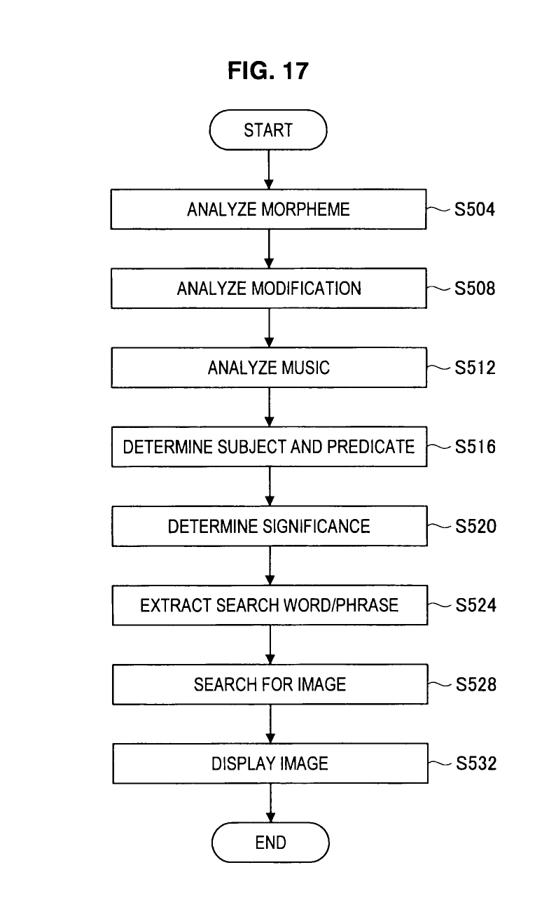

The configuration of the music playback device 20-3 in accordance with the third embodiment has been described above. Next, the operation of the music playback device 20-3 in accordance with the third embodiment will be described with reference to FIG. 17.

FIG. 17 is a flowchart showing the operation of the music playback device 20-3 in accordance with the third embodiment. As shown in FIG. 17, first, the morphological analysis unit 252 of the music playback device 20-3 analyzes the lyrics of at least a part of the target music (S504). Then, the modification analysis unit 254 analyzes the modification of each word/phrase obtained by the morphological analysis unit 252 (S508). In addition, the music analysis unit 253 analyzes the melody part, tempo, and the like of the target music (S512).

Next, the subject/predicate determination unit 255 determines the subject and predicate of each sentence that constitutes the lyrics (S516), and the significance determination unit 256 determines the significance of each word/phrase that constitutes the subject determined by the subject/predicate determination unit 255 (S520).

Then, the communication unit 264 operates in cooperation with the image search server 30, or the search unit 268 acquires an image using a search word/phrase extracted by the word/phrase extraction unit 258 (S528). After that, the display control unit 280 causes the image display unit 284 to display the image acquired by the communication unit 264 or the search unit 268 with a movement in accordance with the predicate (S532).

As described above, the music playback device 20-3 in accordance with the third embodiment of the present disclosure can analyze the lyrics of music, analyze the subject and predicate that constitute the lyrics, extract a noun from the subject as a search word/phrase, acquire an image using the extracted word/phrase, and display the acquired image with a movement in accordance with the predicate during playback of the music.

### 2-4. Fourth Embodiment

Next, the fourth embodiment of the present disclosure will be described. In the fourth embodiment of the present disclosure, a method is proposed that includes creating an image data file associated with music in advance, and playing back the image data file at the same time as playing back the music.

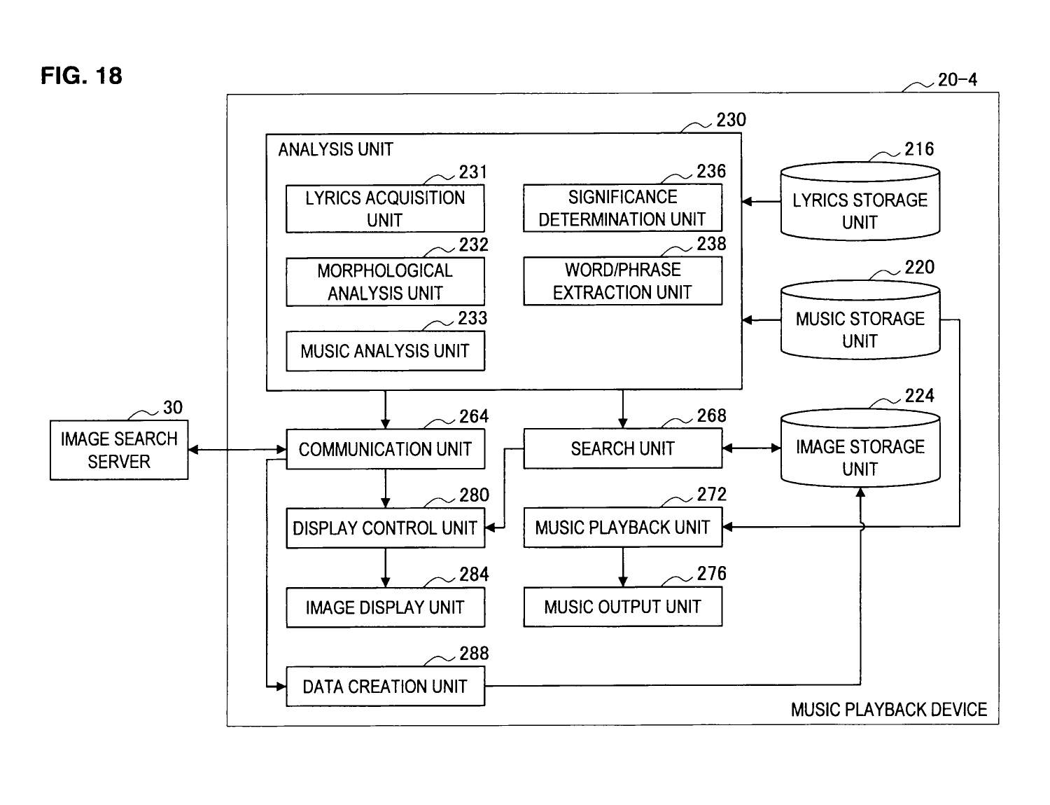

FIG. 18 is a functional block diagram showing the configuration of a music playback device 20-4 in accordance with the fourth embodiment of the present disclosure. As shown in FIG. 18, the music playback device 20-4 in accordance with the fourth embodiment includes a lyrics storage unit 216, a music storage unit 220, an image storage unit 224, an analysis unit 230, a communication unit 264, a search unit 268, a music playback unit 272, a music output unit 276, a display control unit 280, an image display unit 284, and a data creation unit 288. The aforementioned configuration of the music playback device 20-4 has a configuration common to the configuration of the music playback device 20-1 in accordance with the first embodiment. Thus, hereinafter, a configuration that is different from the configuration of the music playback device 20-1 in accordance with the first embodiment will mainly be described.

The communication unit 264, after the music data is acquired and before playback of the music data is started, acquires images from a network using a search word/phrase extracted by the analysis unit 230. Herein, the communication unit 264, using a search word/phrase in the range of each sentence, each line, each melody part, or the like of the lyrics, acquires images corresponding to each range.

The data creation unit 288, on the basis of the images acquired by the communication unit 264, creates moving image data (e.g., an image data file such as MPEG) in which each image appears at the playback timing in the corresponding range of the music). Note that each image may be subjected to the display control described in the first to third embodiments. In addition, the data creation unit 288 may create moving image data including music data. Further, the data creation unit 288 may create moving image data of a plurality of patterns for a single piece of music.

Although an example has been described above in which the image data file is moving image data, the present disclosure is not limited thereto. For example, the image data file may be a data file obtained by associating an image acquired by the communication unit 264 with the target music as well as the timing of displaying the image in the music.

The moving image data created by the data creation unit 288 as described above is stored in the image storage unit 224.

After that, when the music is played back, the search unit 268 searches for moving image data corresponding to the music from the image storage unit 224, and the display control unit 280 plays back the moving image data retrieved by the search unit 268 and causes the image display unit 284 to display a playback screen. Note that the display control unit 280, when the moving image data does not include music data, changes the playback speed of the moving image data in accordance with the music playback speed.

When the image data file retrieved by the image storage unit 224 is a data file obtained by associating an image with the target music as well as the timing of displaying the image in the music, the display control unit 280 may control the image display in accordance with the display timing of each image included in the data file.

As described above, the music playback device 20-4 in accordance with the fourth embodiment of the present disclosure also has a function of a data creation device that creates an image data file. Thus, the music playback device 20-4 can, during playback of music, display an image using the image data file created in advance.

(Supplement)

Although an example has been described in which the image data file creation function is mounted on the music playback device 20-4, the image data file creation function may also be mounted on the server on the network side. In such a case, the music playback device 20-4 can display an image in accordance with music by acquiring an image data file from the server.

In addition, the search unit 268 may, during playback of music, selectively search for an image data file (moving image) that has never been used before. In addition, when a given period of time has elapsed since an image is acquired by the communication unit 264 or when all of the image data files created for given music have been used up for display, the communication unit 264 may acquire images again to update the images in the image storage unit 224. Alternatively, if an image data file associated with the music is not stored in the image storage unit 224 during playback of the music, the communication unit 264 may acquire images in real time from a network during playback of the music.

Although an example has been described above in which an image data file is created before music is played back, the data creation unit 288 may create an image data file using a display created by the display control unit 280 during playback of the music.

### 3. Conclusion

As described above, according to the first to fourth embodiments of the present disclosure, a user can not only audibly perceive the music, but also visually perceive an image in accordance with the lyrics of the music. Thus, the user can enjoy the music more deeply.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, the steps in the process of the music playback device 20 in this specification need not necessarily be processed in a time-series order in accordance with the order described in the flowchart. For example, the steps in the process of the music playback device 20 may be performed in an order different from that described in the flowchart, or be processed in parallel.

It is also possible to create a computer program for causing hardware incorporated in the music playback device 20, such as the CPU 201, the ROM 202, and the RAM 203, to exert a function that is equivalent to each of the aforementioned configurations of the music playback device 20. In addition, a storage medium having the computer program stored therein is also provided.

Additionally, the present technology may also be configured as below.
(1)

A music playback device comprising:

a playback unit configured to playback music;

an analysis unit configured to analyze lyrics of the music and extract a word or a phrase included in the lyrics;

an acquisition unit configured to acquire an image using the word or the phrase extracted by the analysis unit; and

a display control unit configured to, during playback of the music, cause a display device to display the image acquired by the acquisition unit.
(2)

The music playback device according to (1), wherein

the analysis unit analyzes lyrics of a part of the music, and

the display control unit, during playback of the part of the music, causes the display device to display an image acquired by the acquisition unit using the word or the phrase extracted from the lyrics of the part of the music.
(3)

The music playback device according to (1) or (2), wherein the analysis unit determines a significance of each word or phrase included in the lyrics, and extracts at least one word or phrase on the basis of the significance of each word or phrase.
(4)

The music playback device according to (3), wherein the analysis unit determines the significance of each word or phrase on the basis of at least one of a word class of each word or phrase, a melody part to which the part of the music belongs, a volume, or a rhythm.
(5)

The music playback device according to (3) or (4), wherein the display control unit controls a display size of the image in accordance with the significance of the word or the phrase used for the acquisition of the image.
(6)

The music playback device according to any one of (1) to (5), wherein the display control unit controls a movement of the image in accordance with the rhythm of the music.
(7)

The music playback device according to any one of (1) to (6), wherein the acquisition unit acquires one or more images using at least one word or phrase extracted by the analysis unit, and

the display control unit causes the display device to display the one or more images acquired by the acquisition unit during playback of the part of the music.
(8)

The music playback device according to any one of (1) to (7), wherein the acquisition unit acquires the number of images, the number corresponding to a time required to play back the part of the music.
(9)

The music playback device according to (8), wherein the display control unit causes the display device to sequentially display the one or more images acquired by the acquisition unit.
(10)

The music playback device according (8), wherein the display control unit causes the one or more images acquired by the acquisition unit to be displayed in different regions of a display screen of the display device.
(11)

The music playback device according to (8), wherein the display control unit causes the one or more images acquired by the acquisition unit to be displayed in an overlapping region of a display screen of the display device while setting transparency of the one or more images.
(12)

The music playback device according to (11), wherein the display control unit controls the transparency of each of the one or more images in accordance with the significance of the word or the phrase used for the acquisition of the one or more images.
(13)

The music playback device according to any one of (3) to (12), wherein the analysis unit extracts a single word or phrase on the basis of the significance of each word or phrase, and further extracts a word or a phrase related to the extracted single word or phrase.
(14)

The music playback device according to (13), wherein the acquisition unit searches for an image through AND operation of a plurality of words or phrases extracted by the analysis unit.
(15)

The music playback device according to (3), wherein

the analysis unit analyzes a subject and a predicate of the lyrics of the part of the music, and extracts a word or a phrase from the subject, and

the display control unit causes the display device to display the image acquired by the acquisition unit using the word or the phrase extracted from the subject, with a movement in accordance with the predicate.
(16)

The music playback device according to any one of (1) to (15), further comprising:

a data creation unit configured to create an image data file associated with the music on the basis of an image acquired from a network by the acquisition unit; and

a storage unit configured to store the image data file created by the data creation unit, wherein

the acquisition unit, during playback of the music, acquires the image data file stored in the storage unit in association with the music.
(17)

A music playback method, comprising:

analyzing lyrics of music and extracting a word or a phrase included in the lyrics;

acquiring an image using the extracted word or phrase; and

causing a display device to display the acquired image during playback of the music.
(18)

A program for causing a computer to function as:

a playback unit configured to play back music;

an analysis unit configured to analyze lyrics of the music and extract a word or a phrase included in the lyrics;

an acquisition unit configured to acquire an image using the word or the phrase extracted by the analysis unit; and

a display control unit configured to, during playback of the music, cause a display device to display the image acquired by the acquisition unit.
(19)

A data creation device comprising:

an analysis unit configured to analyze lyrics of music and extract a word or a phrase included in the lyrics;

an acquisition unit configured to acquire an image from a network using the word or the phrase extracted by the analysis unit; and

a data creation unit configured to create an image data file associated with the music on the basis of the image acquired by the acquisition unit.

The present disclosure contains subject matter related to that disclosed in Japanese Priority Patent Application JP 2011-083961 filed in the Japan Patent Office on Apr. 5, 2011, the entire content of which is hereby incorporated by reference.

What is claimed is:

1. A music playback device comprising:
a playback unit configured to playback music;
an analysis unit configured to analyze lyrics of the music and extract a word or a phrase included in the lyrics;
an acquisition unit configured to acquire an image using the word or the phrase extracted by the analysis unit; and
a display control unit configured to, during playback of the music, cause a display device to display the image acquired by the acquisition unit.

2. The music playback device according to claim 1, wherein
the analysis unit analyzes lyrics of a part of the music, and
the display control unit, during playback of the part of the music, causes the display device to display an image acquired by the acquisition unit using the word or the phrase extracted from the lyrics of the part of the music.

3. The music playback device according to claim 2, wherein the analysis unit determines a significance of each word or phrase included in the lyrics, and extracts at least one word or phrase on the basis of the significance of each word or phrase.

4. The music playback device according to claim 3, wherein the analysis unit determines the significance of each word or phrase on the basis of at least one of a word class of each word or phrase, a melody part to which the part of the music belongs, a volume, or a rhythm.

5. The music playback device according to claim 4, wherein the display control unit controls a display size of the image in accordance with the significance of the word or the phrase used for the acquisition of the image.

6. The music playback device according to claim 5, wherein the display control unit controls a movement of the image in accordance with the rhythm of the music.

7. The music playback device according to claim 6, wherein
the acquisition unit acquires one or more images using at least one word or phrase extracted by the analysis unit, and
the display control unit causes the display device to display the one or more images acquired by the acquisition unit during playback of the part of the music.

8. The music playback device according to claim 7, wherein the acquisition unit acquires the number of images, the number corresponding to a time required to play back the part of the music.

9. The music playback device according to claim 8, wherein the display control unit causes the display device to sequentially display the one or more images acquired by the acquisition unit.

10. The music playback device according to claim 8, wherein the display control unit causes the one or more images acquired by the acquisition unit to be displayed in different regions of a display screen of the display device.

11. The music playback device according to claim 8, wherein the display control unit causes the one or more images acquired by the acquisition unit to be displayed in an overlapping region of a display screen of the display device while setting transparency of the one or more images.

12. The music playback device according to claim 11, wherein the display control unit controls the transparency of each of the one or more images in accordance with the significance of the word or the phrase used for the acquisition of the one or more images.

13. The music playback device according to claim 3, wherein the analysis unit extracts a single word or phrase on the basis of the significance of each word or phrase, and further extracts a word or a phrase related to the extracted single word or phrase.

14. The music playback device according to claim 13, wherein the acquisition unit searches for an image through AND operation of a plurality of words or phrases extracted by the analysis unit.

15. The music playback device according to claim 3, wherein the analysis unit analyzes a subject and a predicate of the lyrics of the part of the music, and extracts a word or a phrase from the subject, and the display control unit causes the display device to display the image acquired by the acquisition unit using the word or the phrase extracted from the subject, with a movement in accordance with the predicate.

16. The music playback device according to claim 1, further comprising:
a data creation unit configured to create an image data file associated with the music on the basis of an image acquired from a network by the acquisition unit; and
a storage unit configured to store the image data file created by the data creation unit, wherein
the acquisition unit, during playback of the music, acquires the image data file stored in the storage unit in association with the music.

17. A music playback method, comprising:
analyzing lyrics of music and extracting a word or a phrase included in the lyrics;
acquiring an image using the extracted word or phrase; and
causing a display device to display the acquired image during playback of the music.

18. A program for causing a computer to function as:
a playback unit configured to play back music;
an analysis unit configured to analyze lyrics of the music and extract a word or a phrase included in the lyrics;
an acquisition unit configured to acquire an image using the word or the phrase extracted by the analysis unit; and
a display control unit configured to, during playback of the music, cause a display device to display the image acquired by the acquisition unit.

19. A data creation device comprising:
an analysis unit configured to analyze lyrics of music and extract a word or a phrase included in the lyrics;
an acquisition unit configured to acquire an image from a network using the word or the phrase extracted by the analysis unit; and
a data creation unit configured to create an image data file associated with the music on the basis of the image acquired by the acquisition unit.
